(19) United States
(12) Patent Application Publication
(10) Pub. No.: US 2025/0217924 A1
(43) Pub. Date: Jul. 3, 2025

(54) ROBUST FRAME REGISTRATION FOR MULTI-FRAME IMAGE PROCESSING

(71) Applicant: Samsung Electronics Co., Ltd., Suwon-si, Gyeonggi-do (KR)

(72) Inventors: Ibrahim E. Pekkucuksen, Plano, TX (US); Nguyen Thang Long Le, Garland, TX (US); Hamid R. Sheikh, Allen, TX (US)

(21) Appl. No.: 18/829,909

(22) Filed: Sep. 10, 2024

Related U.S. Application Data
(60) Provisional application No. 63/615,205, filed on Dec. 27, 2023.

(51) Int. Cl. G06T 3/14; G06T 3/18; G06T 7/33

(52) U.S. Cl. CPC G06T 3/14; G06T 3/18; G06T 7/337; G06T 2207/20021

(57) ABSTRACT

A method includes obtaining, using at least one processing device of an electronic device, multiple image frames capturing a scene. The method also includes selecting, using the at least one processing device, a reference frame among the image frames. The method further includes aligning, using the at least one processing device, each of one or more non-reference frames among the image frames with the reference frame by (i) performing tile-based registration of the non-reference frame to the reference frame, (ii) performing feature-based registration of the non-reference frame to the reference frame, (iii) aggregating first motion vectors generated during the tile-based registration and second motion vectors generated during the feature-based registration, and (iv) warping the non-reference frame based on the aggregated motion vectors to generate an aligned non-reference frame. The reference frame and the one or more aligned non-reference frames may be blended to generate a final image of the scene.

### CROSS-REFERENCE TO RELATED APPLICATION AND PRIORITY CLAIM

This application claims priority under 35 U.S.C. § 119 (e) to U.S. Provisional Patent Application No. 63/615,205 filed on Dec. 27, 2023, which is hereby incorporated by reference in its entirety.

### TECHNICAL FIELD

This disclosure relates generally to imaging systems. More specifically, this disclosure relates to robust frame registration for multi-frame image processing.

### BACKGROUND

Many mobile electronic devices, such as smartphones and tablet computers, include cameras that can be used to capture still and video images. Multi-frame imaging is a technique that is often employed by mobile electronic devices and other image capture devices. In multi-frame imaging, multiple image frames of a scene are captured at or near the same time, and the image frames are blended or otherwise combined to produce a final image of the scene. This approach can help to significantly improve the visual quality of the final images.

### SUMMARY

This disclosure relates to robust frame registration for multi-frame image processing.

In a first embodiment, a method includes obtaining, using at least one processing device of an electronic device, multiple image frames capturing a scene. The method also includes selecting, using the at least one processing device, a reference frame among the image frames. The method further includes aligning, using the at least one processing device, each of one or more non-reference frames among the image frames with the reference frame by (i) performing tile-based registration of the non-reference frame to the reference frame, (ii) performing feature-based registration of the non-reference frame to the reference frame, (iii) aggregating first motion vectors generated during the tile-based registration and second motion vectors generated during the feature-based registration, and (iv) warping the non-reference frame based on the aggregated motion vectors to generate an aligned non-reference frame.

In a second embodiment, an electronic device includes at least one imaging sensor configured to capture multiple image frames of a scene. The electronic device also includes at least one processing device configured to obtain the image frames, select a reference frame among the image frames, and align each of one or more non-reference frames among the image frames with the reference frame. To align each non-reference frame with the reference frame, the at least one processing device is configured to (i) perform tile-based registration of the non-reference frame to the reference frame, (ii) perform feature-based registration of the non-reference frame to the reference frame, (iii) aggregate first motion vectors generated during the tile-based registration and second motion vectors generated during the feature-based registration, and (iv) warp the non-reference frame based on the aggregated motion vectors to generate an aligned non-reference frame.

In a third embodiment, a non-transitory machine readable medium contains instructions that when executed cause at least one processor to obtain multiple image frames capturing a scene, select a reference frame among the image frames, and align each of one or more non-reference frames among the image frames with the reference frame. The instructions that when executed cause the at least one processor to align each non-reference frame with the reference frame include instructions that when executed cause the at least one processor to (i) perform tile-based registration of the non-reference frame to the reference frame, (ii) perform feature-based registration of the non-reference frame to the reference frame, (iii) aggregate first motion vectors generated during the tile-based registration and second motion vectors generated during the feature-based registration, and (iv) warp the non-reference frame based on the aggregated motion vectors to generate an aligned non-reference frame.

Any single one or any combination of the following features may be used with the first, second, or third embodiment. For each non-reference frame, the tile-based registration may include dividing the non-reference frame into tiles, comparing each tile in the non-reference frame to a neighborhood of tiles in the reference frame, selecting a tile in the neighborhood of tiles in the reference frame based on the comparison, and generating at least one of the first motion vectors based on the selected tile in the neighborhood of tiles in the reference frame. For each non-reference frame, the feature-based registration may include extracting features from the non-reference frame, comparing each feature in the non-reference frame to a corresponding feature in the reference frame, selecting one or more of the features based on the comparison, and generating at least one of the second motion vectors based on the one or more selected features. For each non-reference frame, the non-reference frame may be warped based on the aggregated motion vectors by determining a warping of the non-reference frame based on the aggregated motion vectors and applying the warping to the non-reference frame in order to generate the aligned non-reference frame. The warping of the non-reference frame based on the aggregated motion vectors may be determined using a weighted perspective model to generate a transformation matrix to be applied to the non-reference frame. Segmentation of the image frames may be performed to identify different portions of the scene captured in the image frames, and one or more segments in the image frames associated with a sky within the scene may be identified. The tile-based registration and/or the feature-based registration may be performed in the one or more segments in the image frames associated with the sky and may not be performed or may be performed differently in other segments in the image frames associated with other portions of the scene. The reference frame and the one or more aligned non-reference frames may be blended to generate a final image of the scene.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example multi-frame image processing pipeline in accordance with this disclosure;

FIG. 3 illustrates an example functional architecture that supports robust frame registration for multi-frame image processing in accordance with this disclosure;

FIG. 4 illustrates an example tile-based registration of a non-reference frame to a reference frame to support robust frame registration for multi-frame image processing in accordance with this disclosure;

FIG. 5 illustrates an example feature-based registration of a non-reference frame to a reference frame to support robust frame registration for multi-frame image processing in accordance with this disclosure;

FIG. 6 illustrates an example image segmentation that may be used as part of robust frame registration for multi-frame image processing in accordance with this disclosure;

FIG. 7 illustrates an example weighted perspective modeling technique that may be used as part of robust frame registration for multi-frame image processing in accordance with this disclosure;

FIG. 8 illustrates an example functional architecture using weighted perspective modeling that supports robust frame registration for multi-frame image processing in accordance with this disclosure;

FIGS. 9 and 10 illustrate example results of robust frame registration for multi-frame image processing in accordance with this disclosure; and

FIG. 11 illustrates an example method for robust frame registration for multi-frame image processing in accordance with this disclosure.

### DETAILED DESCRIPTION

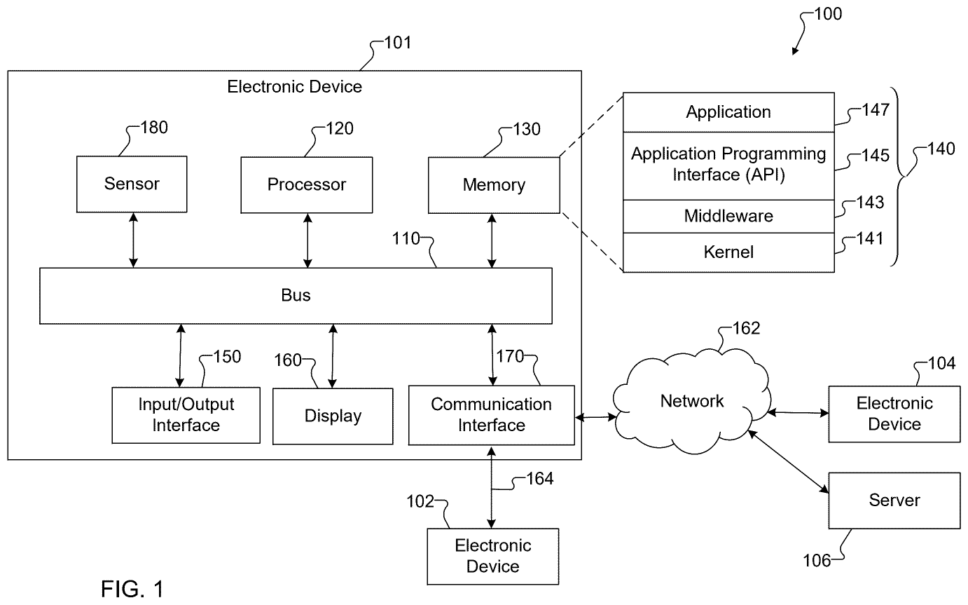

FIGS. 1 through 11, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, many mobile electronic devices, such as smartphones and tablet computers, include cameras that can be used to capture still and video images. Multi-frame imaging is a technique that is often employed by mobile electronic devices and other image capture devices. In multi-frame imaging, multiple image frames of a scene are captured at or near the same time, and the image frames are blended or otherwise combined to produce a final image of the scene. This approach can help to significantly improve the visual quality of the final images.

In many image processing pipelines, multiple image frames are aligned during a process called registration, which typically attempts to align corresponding contents (such as common objects or image points) in the image frames. However, many registration techniques can suffer from problems in the presence of noise, such as when portions of the image frames being processed lack a significant amount of image content. Observed noise in an imaging system is typically a combination of read noise and shot noise. Read noise results from the process of counting the number of photons using a sensor, while shot noise results from the randomness in the arrival of the photons at the sensor.

In low-light situations (such as during nighttime image capture), the number of photons captured by a sensor decreases, and the observed noise tends to be dominated primarily by read noise. Nighttime capture of the sky or other generally-consistent background is one scenario in which the noise level can be high and the scene content can be limited, which makes frame registration prone to failure. Extreme low-light capture is another scenario in which scene content (even if it is available) tends to be obscured by high noise levels, which again makes frame registration prone to failure. Motion in these or other scenarios can also make it more difficult to perform frame registration. The inability to successfully perform frame registration may be immediately and easily noticeable to users. For example, when capturing images of the night sky, the inability to successfully perform frame registration may cause the resulting images to have stars that are blurry or smeared (rather than single points of light), which can be easily seen by viewers.

This disclosure provides various techniques for robust frame registration for multi-frame image processing. As described in more detail below, multiple image frames capturing a scene can be obtained, a reference frame can be selected among the image frames, and each of one or more non-reference frames among the image frames can be aligned with the reference frame. The alignment here can include (i) performing tile-based registration of the non-reference frame to the reference frame, (ii) performing feature-based registration of the non-reference frame to the reference frame, (iii) aggregating first motion vectors generated during the tile-based registration and second motion vectors generated during the feature-based registration, and (iv) warping the non-reference frame based on the aggregated motion vectors to generate an aligned non-reference frame. The reference frame and the one or more aligned non-reference frames may be blended to generate a final image of the scene. In some cases, a segmentation of the image frames may be performed to identify different portions of the scene captured in the image frames, and one or more segments in the image frames associated with a sky within the scene can be identified. The tile-based registration and/or the feature-based registration may be performed in the one or more segments in the image frames associated with the sky and may not be performed or may be performed differently in other segments in the image frames associated with other portions of the scene.

In this way, the disclosed techniques can be used to reduce the number of frame registration failures that are experienced in a multi-frame image processing pipeline. As a result, the disclosed techniques can help to provide more robust frame registration, which can allow multi-frame image processing to occur more effectively and produce improved results. For example, the resulting final images of scenes may have less blur and may be clearer. As a particular example, images captured in low-light situations (such as at night or in extreme low-light conditions) can be clearer and have less blur. Thus, for instance, stars in the night sky can appear as points of light rather than smears or smudges. Among other things, the disclosed techniques can therefore provide for improved imaging and increased user satisfaction.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to robust frame registration for multi-frame image processing.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform robust frame registration for multi-frame image processing. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to robust frame registration for multi-frame image processing.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

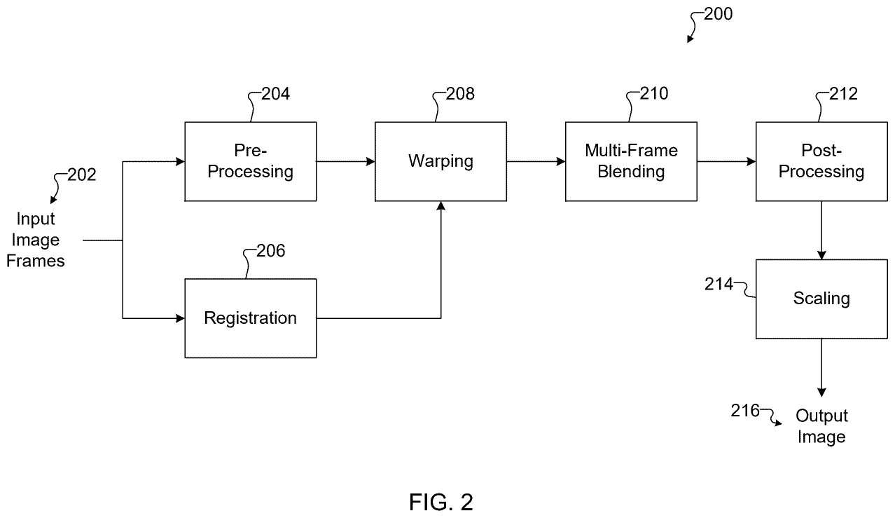

FIG. 2 illustrates an example multi-frame image processing pipeline 200 in accordance with this disclosure. For case of explanation, the multi-frame image processing pipeline 200 shown in FIG. 2 is described as being implemented on or supported by the electronic device 101 in the network configuration 100 of FIG. 1. However, the multi-frame image processing pipeline 200 shown in FIG. 2 could be implemented on or supported by any other suitable device(s) and in any other suitable system(s).

As shown in FIG. 2, the multi-frame image processing pipeline 200 generally operates to receive and process input image frames 202. Each input image frame 202 represents an image frame captured of a scene. Depending on the implementation, the input image frames 202 could be captured simultaneously using different cameras or other imaging sensors 180 of the electronic device 101 or captured sequentially (such as in burst or in rapid succession) using one or more cameras or other imaging sensors 180 of the electronic device 101. In some cases, the input image frames 202 can be captured in response to a capture event, such as when the processor 120 detects a user initiating image capture by depressing a hard or soft button of the electronic device 101. The input image frames 202 may have any suitable resolution(s), and the resolution of each input image frame 202 can depend on the capabilities of the imaging sensor(s) 180 in the electronic device 101 and possibly on one or more user settings affecting the resolution. In some embodiments, the input image frames 202 may represent raw image frames, RGB image frames, or image frames in any other suitable image data space.

In some embodiments, the input image frames 202 may include image frames captured using different exposure levels, such as when the input image frames 202 include one or more shorter-exposure image frames and one or more longer-exposure image frames. As a particular example, the input image frames 202 may include one or more image frames captured at an EV−0 exposure level, one or more image frames captured at an EV−2 exposure level, and one or more image frames captured at an EV−4 exposure level. Note that these exposure levels are for illustration only and that image frames 202 may be captured at other or additional exposure levels, such as EV−1, EV−3, EV−5, EV−6, or EV+1 exposure levels. In other embodiments, the input image frames 202 may include image frames captured using a common exposure level.

The input image frames 202 are provided to a pre-processing function 204, which generally operates to pre-process the input image frames 202 in order to prepare the input image frames 202 for blending or other use. As an example, the pre-processing function 204 may be used to perform de-noising in order to reduce the amount of noise contained in the input image frames 202. As another example, the pre-processing function 204 may be used to perform image enhancement in order to enhance or improve the appearance of scene content captured in the input image frames 202. As yet another example, the pre-processing function 204 may be used to perform image segmentation in which the input image frames 202 are processed to identify discrete objects, foreground, and background in the input image frames 202. In general, the pre-processing function 204 may involve any desired pre-processing of the input image frames 202.

The input image frames 202 are also provided to a registration function 206, which generally operates to determine how to align the input image frames 202 in order to produce aligned image frames. A warping function 208 can be used to warp or otherwise adjust one or more of the pre-processed input image frames 202 based on the determination of the registration function 206 in order to produce substantially-aligned versions of the input image frames 202. For example, the registration function 206 may determine how one or more input image frames 202 would need to be warped or otherwise modified in order to more closely align scene content captured in the input image frames 202, and the warping function 208 may then warp or otherwise modify one or more of the pre-processed input image frames 202 in order to more closely align the scene content. In some cases, the registration function 206 may select a reference frame from among the input image frames 202, and the registration function 206 may determine how to warp or otherwise adjust one or more non-reference frames from among the input image frames 202 in order to more closely align scene content of each non-reference frame with scene content of the reference frame. The registration function 206 can be implemented as described below in order to provide for robust frame registration.

In some cases, registration may be needed in order to compensate for misalignment caused by the electronic device 101 moving or rotating in between image captures, which causes objects in the input image frames 202 to move or rotate slightly (as is common with handheld devices). Note that one or more of the input image frames 202 may be discarded here, such as when the one or more input image frames 202 cannot be successfully aligned with other input image frames 202 by the registration function 206. This is one reason robust frame registration may be needed or desired. Discarding input image frames 202 reduces the amount of image data available for use during image processing, which can negatively impact the quality of images generated by the multi-frame image processing pipeline 200. Reducing the number of pre-processed input image frames 202 that are discarded due to registration failures can therefore help to increase the quality of the images generated by the multi-frame image processing pipeline 200.

Aligned input image frames 202 generated by the warping function 208 are provided to a multi-frame blending function 210, which generally operates to combine the aligned input image frames 202 in order to produce a blended image. The multi-frame blending function 210 may use any suitable technique to combine image data from multiple image frames in order to produce a blended image. For example, the multi-frame blending function 210 may take the reference frame and replace one or more portions of the reference frame containing motion with one or more corresponding portions of shorter-exposure image frames. As a particular example, the multi-frame blending function 210 may perform a weighted blending operation to combine the pixel values contained in the aligned input image frames 202. In general, this disclosure is not limited to any particular technique for combining image frames.

The blended image is provided to a post-processing function 212, which generally operates to perform any desired post-processing of the blended image. As an example, the post-processing function 212 may be used to perform deghosting or deblurring in which a machine learning model or other logic can be used to reduce or remove ghosting artifacts or blur in the blended image. As another example, the post-processing function 212 may be used to perform edge noise filtering in which the blended image is processed in order to remove noise from object edges, which can help to provide cleaner edges to objects in the blended image. As yet another example, the post-processing function 212 may be used to perform tone mapping to adjust colors in the blended image. This can be useful or important in various applications, such as when generating high dynamic range (HDR) images. For instance, since generating an HDR image often involves capturing multiple image frames 202 of a scene using different exposures and combining the captured image frames to produce the HDR image, this type of processing can often result in the creation of unnatural tones within the HDR image. Tone mapping can therefore use one or more color mappings to adjust the colors contained in the blended image. As still another example, the post-processing function 212 may be used to perform spatial noise filtering, which can be used to spatially filter the contents of the blended image in order to remove noise from the blended image. In general, the post-processing function 212 may involve any desired post-processing of the blended image.

A scaling function 214 can be used to scale the processed blended image provided by the post-processing function 212. For example, the scaling function 214 may adjust the resolution of the processed blended image in order to achieve a desired resolution, leading to the generation of an output image 216. Note that the scaling function 214 may increase or decrease the resolution of the processed blended image as needed or desired. The output image 216 may be stored, output, or used in any suitable manner. The output image 216 generally represents an image of the scene that is generated by the multi-frame image processing pipeline 200 based on the input image frames 202.

Although FIG. 2 illustrates one example of a multi-frame image processing pipeline 200, various changes may be made to FIG. 2. For example, various components and functions in FIG. 2 may be combined, further subdivided, replicated, or rearranged according to particular needs. Also, one or more additional components or functions may be included if needed or desired. In addition, while FIG. 2 illustrates one example environment in which robust frame registration may be used, the techniques for robust frame registration described in this disclosure may be used in any other suitable environment.

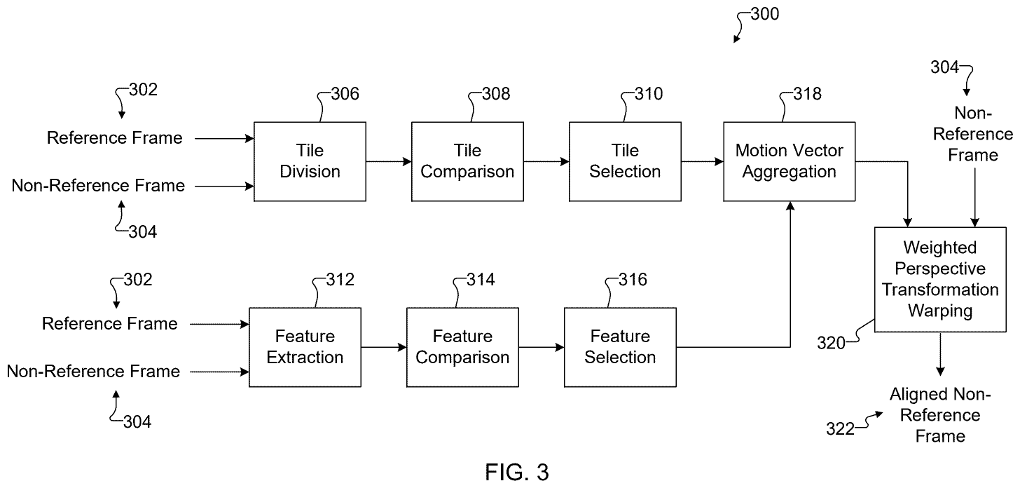

FIG. 3 illustrates an example functional architecture 300 that supports robust frame registration for multi-frame image processing in accordance with this disclosure. More specifically, the functional architecture 300 may be used to at least partially implement the registration function 206 in the multi-frame image processing pipeline 200 of FIG. 2. For case of explanation, the functional architecture 300 shown in FIG. 3 is described as being implemented on or supported by the electronic device 101 in the network configuration 100 of FIG. 1. However, the functional architecture 300 shown in FIG. 3 could be implemented on or supported by any other suitable device(s) and in any other suitable system(s).

As shown in FIG. 3, the functional architecture 300 generally operates to receive and process a reference frame 302 and a non-reference frame 304. The reference frame 302 and the non-reference frame 304 may represent two of the input image frames 202 being processed by the multi-frame image processing pipeline 200. The reference frame 302 may be selected from among the input image frames 202 in any suitable manner. For example, in some cases, the reference frame 302 may represent the first input image frame 202 in a burst or other sequence, or the reference frame 302 may represent the middle input image frame 202 in the burst or other sequence. In other cases, the multi-frame image processing pipeline 200 may implement a reference frame selection (RFS) algorithm used to select the reference frame 302 from among the burst or other sequence of input image frames 202. In general, this disclosure is not limited to any specific technique for identifying a reference frame 302. Each remaining input image frame 202 that is not selected as a reference frame may be referred to as a non-reference or target frame.

The reference frame 302 and the non-reference frame 304 are processed by performing both a tile-based registration (which generally attempts to align tiles of the frames) and a feature-based registration (which generally attempts to align features of the frames). In this example, tile-based registration is implemented using functions 306-310. More specifically, a tile division function 306 can be used to divide the non-reference frame 304 into multiple tiles. Each tile represents a portion (but not all) of the non-reference frame 304. The tile division function 306 can use any suitable technique to divide the non-reference frame 304 into multiple tiles. Depending on the implementation, the tiles of the non-reference frame 304 may or may not overlap with one another. A tile comparison function 308 can compare each tile of the non-reference frame 304 to a neighborhood of tiles in the reference frame 302. For instance, the tile comparison function 308 may compare each tile of the non-reference frame 304 (which is centered at a specified location within the non-reference frame 304) to a collection of tiles in the reference frame 302 (which are centered at or around the same specified location within the reference frame 302). For each tile of the non-reference frame 304, a tile selection function 310 can select one of the tiles from the reference frame 302 that is the closest match to that tile of the non-reference frame 304. For each tile of the non-reference frame 304, this results in the identification of a first motion vector, such as from a center of the tile of the non-reference frame 304 to a center of the closest-matching tile of the reference frame 302.

In some embodiments, these functions 306-310 can be performed in an iterative manner. For example, the functions 306-310 may be performed in a coarse-to-fine manner in which the tiles are first matched at coarser resolutions and then subsequently matched at finer resolutions. This approach may allow tiles of relatively small sizes to eventually be defined and matched between the reference frame 302 and the non-reference frame 304. This type of approach may help to reduce computational complexity while maintaining adequate search coverage when matching the tiles. In some cases, this type of technique may be referred to as a “pyramidal approach” for tile mapping.

In this example, feature-based registration is implemented using functions 312-316. More specifically, a feature extraction function 312 can be used to identify specific features in each of the reference frame 302 and the non-reference frame 304. The specific features may represent any suitable content in each of the reference frame 302 and the non-reference frame 304. For example, the specific features that are identified here may represent points or other portions of specific objects captured in the reference frame 302 and the non-reference frame 304. When the input image frames 202 are captured of nighttime scenes, for instance, the identified features may include stars in the sky of the scene. A feature comparison function 314 can compare the identified features from the reference frame 302 and the non-reference frame 304, and a feature selection function 316 can select matching features from the reference frame 302 and the non-reference frame 304. For example, the feature comparison function 314 may compare features from the reference frame 302 and the non-reference frame 304 using a similarity measure, and the feature selection function 316 can identify features as being matching in the reference frame 302 and the non-reference frame 304 when those features have a smallest or minimum error based on the similarity measures. For each of at least some features of the non-reference frame 304, this results in the identification of a second motion vector, such as from the position of the feature in the non-reference frame 304 to the position of the matching feature in the reference frame 302.

A motion vector aggregation function 318 generally operates to aggregate or combine the first and second motion vectors generated during the tile-based registration and the feature-based registration. This results in the generation of a collection of motion vectors, some from the tile-based registration and some from the feature-based registration. The motion vectors can be provided to a weighted perspective transformation warping function 320, which can be used to implement the warping function 208 described above. The warping function 320 warps the non-reference frame 304 based on the aggregated motion vectors associated with that non-reference frame 304. In this example, the warping function 320 implements weighted perspective transformation, which in some cases may use weighted least squares minimization for a perspective model to help converge to a correct transformation matrix by giving more weight to more reliable motion vectors. The transformation matrix can be applied by the warping function 320 to warp the non-reference frame 304.

The weighted perspective transformation warping function 320 generates an aligned non-reference frame 322, which represents a modified version of the non-reference frame 304 as substantially aligned to the reference frame 302. By using the architecture 300 to process each non-reference frame 304 in a collection of input image frames 202, the architecture 300 can generate a collection of aligned non-reference frames 322, all of which may be substantially aligned to the reference frame 302. The reference frame 302 and the aligned non-reference frame(s) 322 can be provided to the blending function 210 or other function for further processing.

The weighted perspective transformation warping function 320 here can use weights applied to each non-reference frame 304 in order to generate the corresponding aligned non-reference frame 322. In some embodiments, a weighted perspective model may be used to generate a transformation matrix that is applied by the warping function 320 to the non-reference frame 304 in order to generate the aligned non-reference frame 322. Here, the aggregated motion vectors from the aggregation function 318 can be input to the weighted perspective model, and the weighted perspective model can process the aggregated motion vectors and generate the transformation matrix. In the following discussion, M is used to denote the number of motion vectors generated by the tile-based registration, and N is used to denote the number of motion vectors generated by the feature-based registration. In some cases, each motion vector can be defined using horizontal and vertical coordinates, and the weighted perspective model may process 2×(M+N) vector entries.

In particular embodiments, a transformation matrix may be defined as follows.

$$\hat{β} = {( {X}^{T} WX )}^{- 1} {X}^{T} Wy$$

Here, \hat{β} represents the transformation matrix that can be estimated using the weighted perspective model. Also, X represents a matrix derived from match coordinates. For each motion vector associated with a tile or feature match, coordinates [u, v] may be identified in the reference frame 302, and coordinates [x, y] may be identified in the non-reference frame 304. In some cases, the relationships between the coordinates [u, v] and the coordinates [x, y] may be defined as follows.

$$u = \frac{{a}_{0} + {a}_{1} x + {a}_{2} y}{1 + {c}_{1} x + {c}_{2} y} = [ x y 1000 - ux - uy ] [ \begin{matrix}{a}_{1} \\ {a}_{2} \\ {a}_{o} \\ {b}_{1} \\ {b}_{2} \\ {b}_{0} \\ {c}_{1} \\ {c}_{2}\end{matrix} ]$$

$$v = \frac{{b}_{0} + {b}_{1} x + {b}_{2} y}{1 + {c}_{1} x + {c}_{2} y} = [ 000 x y 1 - vx - vy ] [ \begin{matrix}{a}_{1} \\ {a}_{2} \\ {a}_{o} \\ {b}_{1} \\ {b}_{2} \\ {b}_{0} \\ {c}_{1} \\ {c}_{2}\end{matrix} ]$$

Thus, each set of coordinates [u, v] may be defined using two pairs of 1 by 8 vectors. The X matrix can be created by combining the 1 by 8 vectors that describe u and v in terms of the perspective model parameters. In some cases, the X matrix can represent a 2×(M+N) by 8 matrix that encodes match coordinates in terms of the perspective model parameters. Further, W represents a weight vector that defines the weight for the tile or feature match. In some cases, the W vector can represent a 2×(M+N) by 1 vector. In addition, y represents a vector that defines the match coordinates. In some cases, the y vector can represent a 2×(M+N) by 1 vector.

In some embodiments, the motion vector aggregation function 318 may perform an initial filtering of the motion vectors to exclude certain motion vectors from the aggregation. For example, the motion vector aggregation function 318 may exclude one or more motion vectors from the aggregation when the one or more motion vectors appear obviously incorrect, such as when one motion vector has a very different direction and/or amplitude than the rest of the motion vectors. Note that even if this filtering does not occur, the weighted perspective transformation warping function 320 may be used over multiple iterations in some embodiments. For instance, in a first iteration, all motion vectors from the motion vector aggregation function 318 may be used, and the weighted perspective transformation warping function 320 may determine which motion vectors follow one another closely. Other motion vectors may be marked as invalid and excluded from the next iteration of the weighted perspective transformation warping function 320. In practice, this may allow for the refinement of alignment since wrong motion vectors associated with incorrect tile or feature matches may be excluded and no longer affect error calculations during subsequent iterations.

These types of approaches effectively apply weighted least squares minimization to a perspective model in order to provide a weighted perspective model. This makes frame registration more robust by using both tile matching and feature matching and by giving more weight to more-reliable motion vectors. Depending on the implementation and specific use case, tile matching may provide better results when there is adequate local scene content to match between frames reliably, while feature matching may provide better results for flat or more uniform scene content with fewer unique pixel values (such as stars in the night sky). Using both tile and feature matching increases reliability because it allows the architecture 300 to generate and use motion vectors that would otherwise be unavailable. For instance, in a scene with larger or more numerous uniform regions, tile matching may return unreliable or invalid motion vectors, but feature matching can provide coverage of these regions by locking onto rare intensity changes. In noisy image capture scenarios, feature matching may be unreliable even when there is structured scene content, but tile matching can provide coverage of these scenes since accumulating error over an entire tile can have a denoising effect.

Note that the weights used in the weighted perspective model may be determined in any suitable manner. In some embodiments, for example, normalized cross-correlation scores may be used as weights for tile matches, and a combination of different attributes (such as local variance and motion vector magnitude) may be used as weights for feature matches. Weights of tile matches and feature matches may be normalized to give them appropriate representation, such as when normalized cross-correlation values are defined in a range from [−1, 1]. For a matching tile, the normalized cross-correlation value may be at or close to a value of one. By using a baseline weight of one, normalized cross-correlation scores may be used directly without any further computations. When the weighted perspective model is used iteratively, it is also possible to update the weights used in the weighted perspective model after each iteration, which (as noted above) could make explicit filtering or other outlier rejection unnecessary.

Although FIG. 3 illustrates one example of a functional architecture 300 that supports robust frame registration for multi-frame image processing, various changes may be made to FIG. 3. For example, various components and functions in FIG. 3 may be combined, further subdivided, replicated, or rearranged according to particular needs. Also, one or more additional components or functions may be included if needed or desired.

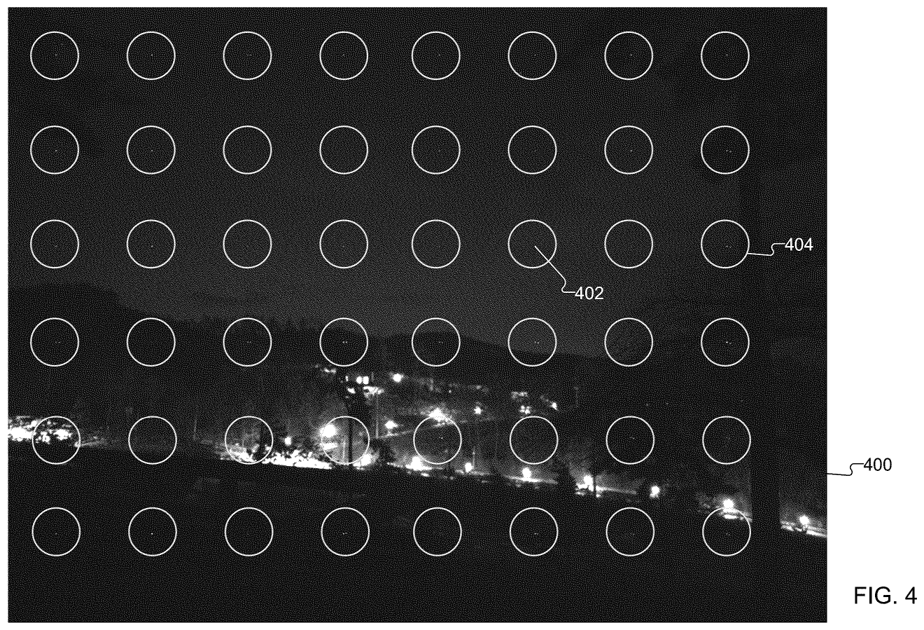

FIG. 4 illustrates an example tile-based registration of a non-reference frame 304 to a reference frame 302 to support robust frame registration for multi-frame image processing in accordance with this disclosure. The tile-based registration here may, for example, be performed using the functions 306-310 in the architecture 300 described above. However, the same or similar tile-based registration may be performed using any other suitable architecture.

As shown in FIG. 4, an image frame 400 represents either a reference frame 302 or a non-reference frame 304. The image frame 400 is divided into tiles, and each tile is associated with a central point 402 that is identified within a corresponding circle 404. The reference frame 302 and the non-reference frame 304 may each be divided into multiple tiles. For each tile of the non-reference frame 304, the tile-based registration performed in the architecture 300 can be used to identify a motion vector between the central point 402 of that tile and the central point 402 of the closest matching tile in the reference frame 302. If there is no motion between the tile of the non-reference frame 304 and the closest-matching tile of the reference frame 302, the central points 402 of those two tiles would overlap, and the associated motion vector would have values of zero. In some cases, the tile-based registration may be performed in a pyramidal or other iterative fashion, such as when the tiles in the reference frame 302 and the non-reference frame 304 are initially larger and become smaller over multiple iterations. The end result here is that, for each non-reference frame 304, the architecture 300 can generate a set of first motion vectors associated with that non-reference frame 304.

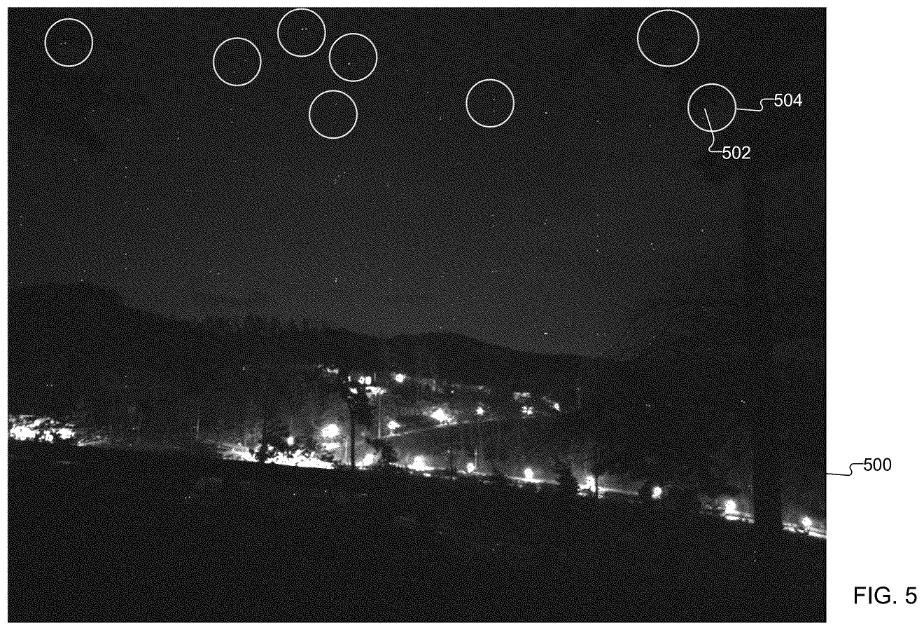

FIG. 5 illustrates an example feature-based registration of a non-reference frame 304 to a reference frame 302 to support robust frame registration for multi-frame image processing in accordance with this disclosure. The feature-based registration here may, for example, be performed using the functions 312-316 in the architecture 300 described above. However, the same or similar feature-based registration may be performed using any other suitable architecture.

As shown in FIG. 5, an image frame 500 represents either a reference frame 302 or a non-reference frame 304. Features 502 within the image frame 500 are identified, and the architecture 300 attempts to match each feature 502 in the non-reference frame 304 with a corresponding feature 502 in the reference frame 302. Circles 504 here are used to represent general locations where at least some matching features 502 have been identified in the reference frame 302 and the non-reference frame 304. The feature-based registration performed in the architecture 300 can be used to identify a motion vector between two matching features 502 (one in the reference frame 302 and one in the non-reference frame 304). If there is no motion between two matching features 502, those features 502 would overlap, and the associated motion vector would have values of zero. Note that because this matching involves features within image frames and not tiles, the features 502 that are identified as being matching can have much more irregularity in terms of positions compared to the tile-based matching. The end result here is that, for each non-reference frame 304, the architecture 300 can generate a set of second motion vectors associated with that non-reference frame 304.

Although FIGS. 4 and 5 illustrate examples of tile-based registration and feature-based registration of a non-reference frame 304 to a reference frame 302 to support robust frame registration for multi-frame image processing, various changes may be made to FIGS. 4 and 5. For example, the specific scene content here is for illustration only. Also, the number of tiles, the number of features, the number of matching tiles, and the number of features shown here are examples only and can easily vary based on (among other things) the specific image frames being processes.

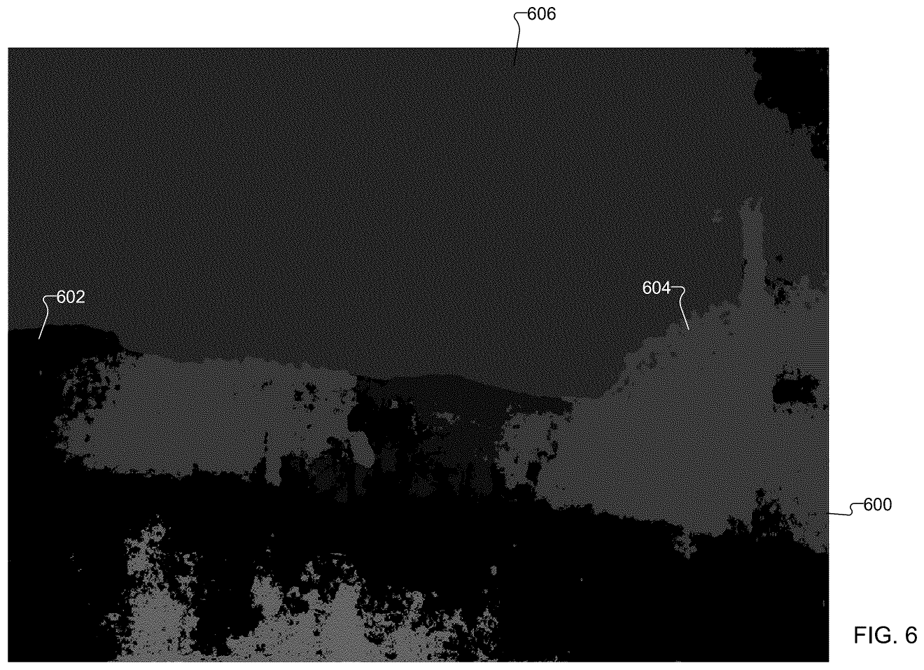

FIG. 6 illustrates an example image segmentation 600 that may be used as part of robust frame registration for multi-frame image processing in accordance with this disclosure. As noted above, image segmentation is a process in which an image frame can be processed to identify discrete objects, foreground, and background in the image frame. In some embodiments, image segmentation classifies each pixel of an image frame as belonging to a specific semantic class of scene content. Any suitable classes of scene content may be supported during image segmentation. As particular examples, each pixel of an image frame may be classified as capturing a part of a person, a specific type of object (such as a vehicle, building, or tree or other greenery), the ground, or the sky. As shown in FIG. 6, the image segmentation 600 in this particular example defines at least one segment 602 associated with the ground, at least one segment 604 associated with trees or other greenery, and at least one segment 606 associated with the sky. In this example, the image segmentation 600 relates to the specific scene shown in the image frames 400 and 500 of FIGS. 4 and 5.

In some embodiments, tile-based registration and/or feature-based registration may be performed by the architecture 300 only for parts of image frames and not across the entirety of the image frames. For example, tile-based registration and/or feature-based registration may be performed by the architecture 300 only for one or more segments of the image segmentation 600 that are associated with one or more specific semantic classes of scene content. In some embodiments, the architecture 300 may perform tile-based registration and/or feature-based registration only in one or more segments 606 associated with the sky in the scene. Thus, for instance, the architecture 300 may perform feature matching only for the segment(s) 606 associated with the sky. In particular embodiments, the architecture 300 may perform tile matching throughout the image frames, but feature matching may be limited to the segment(s) 606 associated with the sky.

In other embodiments, tile-based registration and/or feature-based registration may be modified or adjusted depending on the segment(s) in which the tile-based registration and/or the feature-based registration is being performed. For example, the number of iterations and the sizes of the tiles used during tile-based registration may be adjusted depending on whether the tile-based registration is being performed for one or more segments 606 associated with the sky in the scene or for one or more other types of segments 602, 604. As a particular example, tile-based registration may typically use a pyramid structure having different levels of tiles (such as four levels), where different levels of the pyramid structure can vary from the original resolution of an image frame through various down-scaled versions of the image frame. The tile size at the original resolution of the image frame may be 64 pixels by 64 pixels. However, for registration involving segments 606 of the sky (particularly at night), the pyramid structure may only have two levels, and the tile size at the original resolution of the image frame may be 256 pixels by 256 pixels.

Although FIG. 6 illustrates one example of an image segmentation 600 that may be used as part of robust frame registration for multi-frame image processing, various changes may be made to FIG. 6. For example, the specific scene content here is for illustration only, and the resulting segmentation of that specific scene content is also for illustration only.

As noted above, in some embodiments, a weighted perspective model can be used to perform frame registration. In some cases, weighted perspective modeling can be used to emphasize alignment in a particular part of an image frame by providing weights based on frame coordinates. This means that the weights used as part of the weighted perspective model do not necessarily have to act as a measure of reliability only. In addition or alternatively, the weights can be used to perform localized alignment error minimization. For example, if depth information associated with an image frame 202 is received as an input, an alignment can be generated that minimizes background regions, and another alignment can be generated that minimizes foreground regions. The weighted perspective model here can use the same equations described above, but the weights W can serve a different purpose in these embodiments. Another potential approach is to reduce or minimize errors in different parts of image frames and combine the resulting estimates into a single mesh to achieve reduced overall alignment errors.

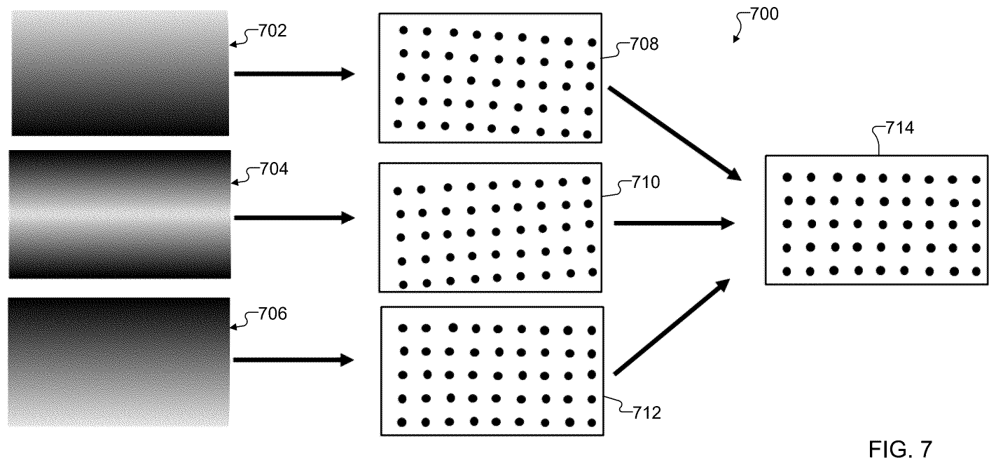

FIG. 7 illustrates an example weighted perspective modeling technique 700 that may be used as part of robust frame registration for multi-frame image processing in accordance with this disclosure. For ease of explanation, the weighted perspective modeling technique 700 shown in FIG. 7 is described as being implemented on or supported by the electronic device 101 in the network configuration 100 of FIG. 1. However, the weighted perspective modeling technique 700 shown in FIG. 7 could be implemented on or supported by any other suitable device(s) and in any other suitable system(s).

As shown in FIG. 7, multiple weight distributions 702, 704, 706 can be defined, where each weight distribution 702, 704, 706 contains weights to be applied to different portions of an image frame. Brighter regions of the weight distributions 702, 704, 706 correspond to higher weights, and darker regions of the weight distributions 702, 704, 706 correspond to lower weights (or vice versa). In this example, the weight distributions 702, 704, 706 generally include horizontal strips of weights, meaning the weights tend to be more consistent side-to-side and more variable up-and-down. Note, however, that this is for illustration only and that other types of uniform or non-uniform weight distributions may be used here.

The weight distributions 702, 704, 706 can be respectively converted into alignment meshes 708, 710, 712. Each alignment mesh 708, 710, 712 includes a number of points with weights identifying an amount of warping to be applied at those points. The weights in each alignment mesh 708, 710, 712 can therefore have the same pattern as the weights defined by the weight distributions 702, 704, 706. In this particular example, for instance, the weights in each row of the alignment meshes 708, 710, 712 may be more consistent with one another, and the weights may vary more between the rows of each alignment mesh 708, 710, 712. This is consistent with the horizontal strips used in this example of the weight distributions 702, 704, 706, although as noted above other weights may be used here.

The alignment meshes 708, 710, 712 are combined to produce a combined mesh 714, which represents a weighted combination of the alignment meshes 708, 710, 712. Each alignment mesh 708, 710, 712 contributes to the combined mesh 714 according to the weight distribution within that alignment mesh 708, 710, 712. As a result, in this particular example, the combined mesh 714 may be dominated by the first alignment mesh 708 in its top portion, by the second alignment mesh 710 in its middle portion, and by the third alignment mesh 712 in its bottom portion. The resulting combined mesh 714 can be used during subsequent warping to warp at least one non-reference frame 304.

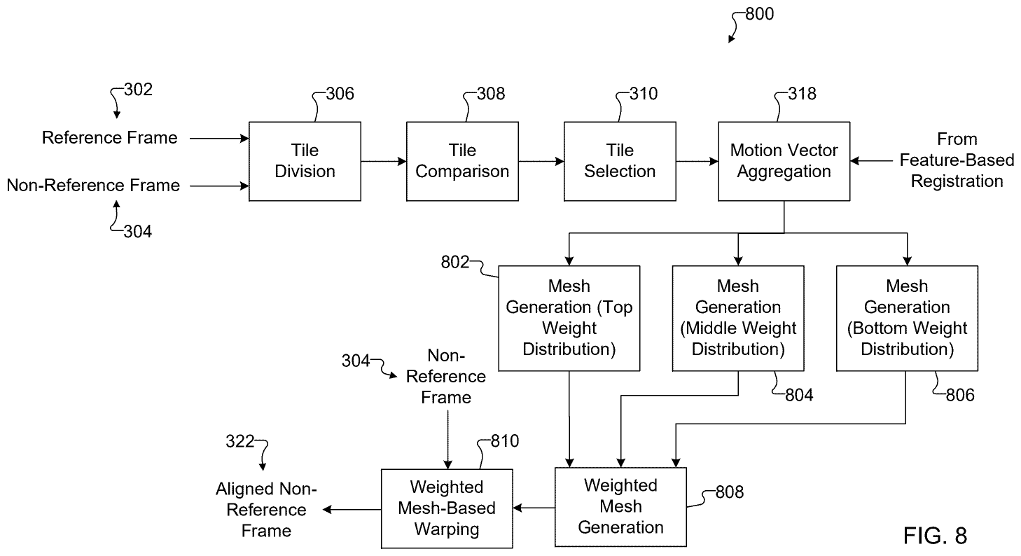

FIG. 8 illustrates an example functional architecture 800 using weighted perspective modeling that supports robust frame registration for multi-frame image processing in accordance with this disclosure. More specifically, the functional architecture 800 may be used to at least partially implement the registration function 206 in the multi-frame image processing pipeline 200 of FIG. 2. For case of explanation, the functional architecture 800 shown in FIG. 8 is described as being implemented on or supported by the electronic device 101 in the network configuration 100 of FIG. 1. However, the functional architecture 800 shown in FIG. 8 could be implemented on or supported by any other suitable device(s) and in any other suitable system(s).

As shown in FIG. 8, the architecture 800 includes a portion of the architecture 300. The functions 312-316 used for feature-based registration are omitted for case of illustration but can be included in the architecture 800. The aggregated motion vectors from the aggregation function 318 here are provided to multiple mesh generation functions 802, 804, 806, each of which can be used to generate a corresponding alignment mesh (such as one of the alignment meshes 708, 710, 712). For example, the mesh generation function 802 may generate the alignment mesh 708 using the top weight distribution 702, the mesh generation function 804 may generate the alignment mesh 710 using the middle weight distribution 704, and the mesh generation function 806 may generate the alignment mesh 712 using the bottom weight distribution 706.

A weighted mesh generation function 808 can be used to combine the alignment meshes produced by the mesh generation functions 802, 804, 806 in order to generate a combined (weighted) mesh 714. The weighted mesh generation function 808 may use any suitable technique to combine the alignment meshes 708, 710, 712 and produce the combined mesh 714. In some embodiments, the weighted mesh generation function 808 may combine the alignment meshes 708, 710, 712 as follows.

$$M = ( {M}^{t} . * {W}^{t} + {M}^{m} . * {W}^{m} + {M}^{b} . * {W}^{b} ) . / ( {W}^{t} + {W}^{m} + {W}^{b} )$$

Here, M represents the combined mesh 714, and M^{t}, M^{m}, and M^{b} respectively represent the alignment meshes 708, 710, 712. Also, W^{t}, W^{m}, and W^{b} represent weights respectively applied to the alignment meshes 708, 710, 712. In addition, “.*” represents an element-wise multiplication operation, and “./” represents an element-wise division operation. A warping function 810 applies the combined mesh 714 to a non-reference frame 304 in order to generate a corresponding aligned non-reference frame 322. For example, the warping function 810 may apply a warping whose strength is based on the associated weighting in the combined mesh 714. As a particular example, the weighted mesh generation function 808 may generate a transformation matrix that is applied to the non-reference frame 304 by the warping function 810.

Although FIG. 7 illustrates one example of a weighted perspective modeling technique 700 that may be used as part of robust frame registration for multi-frame image processing, various changes may be made to FIG. 7. For example, the weighted perspective modeling technique 700 may involve any suitable number of weight distributions and alignment meshes. Also, the number and arrangement of values in the alignment meshes 708, 710, 712 and the combined mesh 714 can vary as needed or desired. Although FIG. 8 illustrates one example of a functional architecture 800 using weighted perspective modeling that supports robust frame registration for multi-frame image processing, various changes may be made to FIG. 8. For instance, various components and functions in FIG. 8 may be combined, further subdivided, replicated, or rearranged according to particular needs. Also, one or more additional components or functions may be included if needed or desired. In addition, any suitable number of mesh generation functions (including a single mesh generation function that is reused) may be supported in the functional architecture 800.

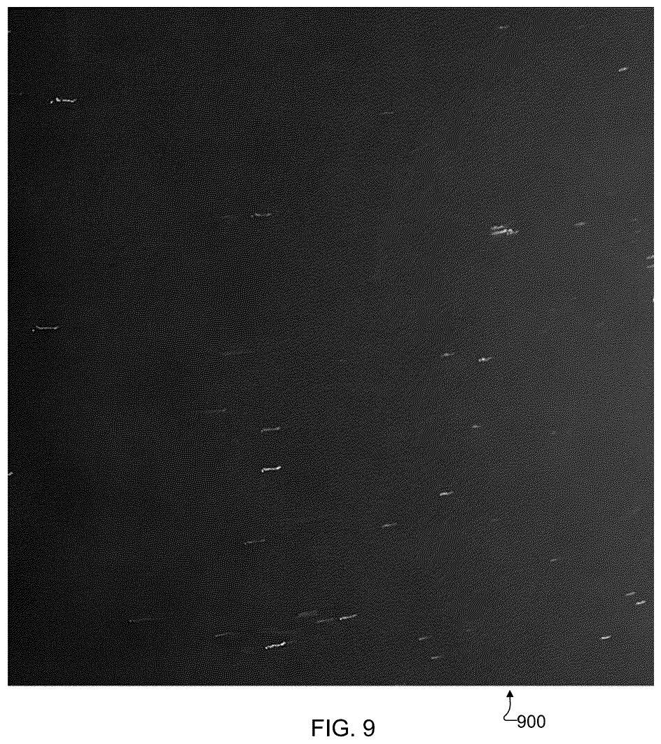

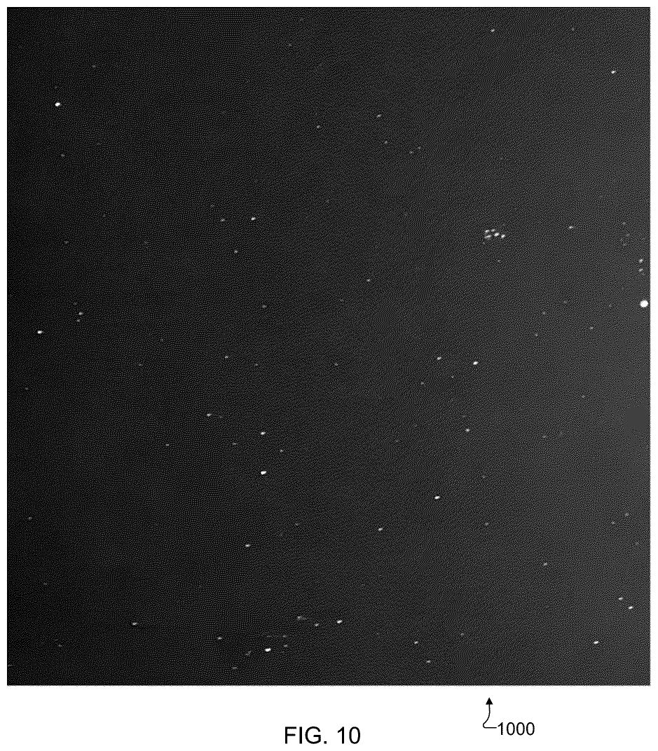

FIGS. 9 and 10 illustrate example results of robust frame registration for multi-frame image processing in accordance with this disclosure. More specifically, FIG. 9 illustrates an example output image 900 that could be generated using a multi-frame image processing pipeline without robust image registration. As can be seen here, the image 900 is quite blurry. This may be caused (among other things) by a failure to properly register one or more input image frames and the subsequent discarding of the non-registered input image frame(s). In contrast, FIG. 10 illustrates an example output image 1000 that could be generated using the multi-frame image processing pipeline 200, which supports robust image registration. As can be seen here, the image 1000 is much clearer, which may be allowed (among other things) by the ability to properly register input image frames more effectively.

Although FIGS. 9 and 10 illustrate one example of results of robust frame registration for multi-frame image processing, various changes may be made to FIGS. 9 and 10. For example, FIGS. 9 and 10 are merely meant to illustrate one example of a type of benefit that might be obtained using the techniques of this disclosure. The specific results that are obtained in any given situation can vary based on the circumstances and based on the specific implementation of the techniques described in this disclosure.

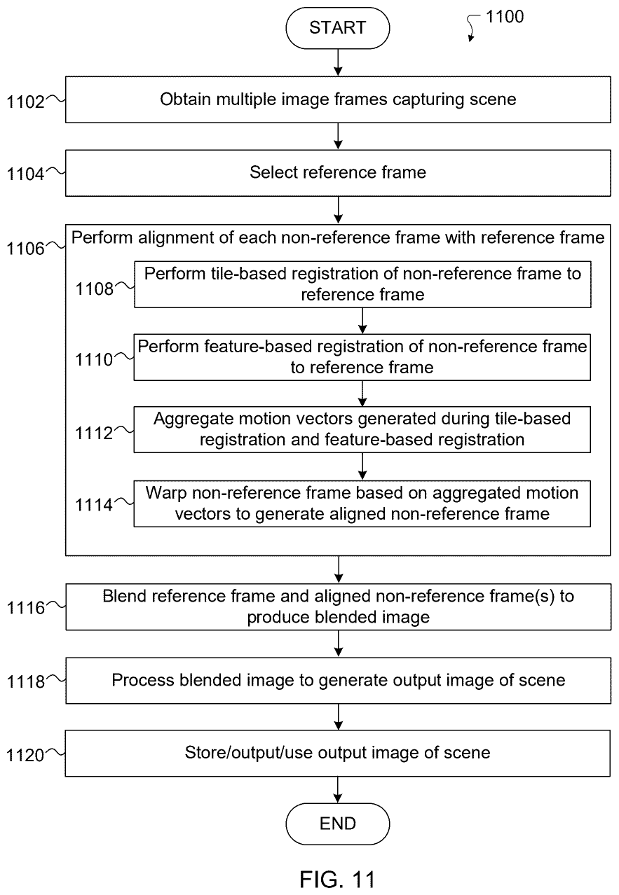

FIG. 11 illustrates an example method 1100 for robust frame registration for multi-frame image processing in accordance with this disclosure. For ease of explanation, the method 1100 of FIG. 11 is described as being performed using the electronic device 101 in the network configuration 100 of FIG. 1, where the electronic device 101 can implement the multi-frame image processing pipeline 200 of FIG. 2 and the functional architecture 300 or 800 of FIG. 3 or 8. However, the method 1100 may be performed using any other suitable device(s), pipeline(s), and architecture(s) and in any other suitable system(s).

As shown in FIG. 11, multiple image frames capturing a scene are obtained at step 1102. This may include, for example, the processor 120 of the electronic device 101 obtaining multiple input image frames 202 using one or more imaging sensors 180 of the electronic device 101, such as by obtaining a burst or other sequence of input image frames 202. A reference frame is selected from among the image frames at step 1104. This may include, for example, the processor 120 of the electronic device 101 selecting the first or middle frame in the sequence of input image frames 202 as the reference frame 302 or using a reference frame selection algorithm to select the reference frame 302 from among the input image frames 202.

Each non-reference frame among the image frames is aligned with the reference frame at step 1106. This may include, for example, the processor 120 of the electronic device 101 using various functions of the architecture 300, 800 to align each non-reference frame 304 with the reference frame 302. As part of the alignment, for each non-reference frame, tile-based registration can be performed to align the non-reference frame to the reference frame at step 1108. This may include, for example, the processor 120 of the electronic device 101 dividing the non-reference frame 304 into tiles, comparing each tile in the non-reference frame 304 to a neighborhood of tiles in the reference frame 302, selecting a tile in the neighborhood of tiles in the reference frame 302 based on the comparison, and generating at least one first motion vector based on the selected tile in the neighborhood of tiles in the reference frame 302. Feature-based registration can be performed to align the non-reference frame to the reference frame at step 1110. This may include, for example, the processor 120 of the electronic device 101 extracting features from the non-reference frame 304, comparing each feature in the non-reference frame 304 to a corresponding feature in the reference frame 302, selecting one or more of the features based on the comparison, and generating at least one second motion vector based on the one or more selected features. The motion vectors generated during the tile-based registration and the feature-based registration are aggregated at step 1112. This may include, for example, the processor 120 of the electronic device 101 aggregating the first and second motion vectors and optionally filtering outliers from the aggregated motion vectors. The non-reference frame is warped based on the aggregated motion vectors to generate an aligned non-reference frame at step 1114. This may include, for example, the processor 120 of the electronic device 101 determining a warping of the non-reference frame 304 based on the aggregated motion vectors and applying the warping to the non-reference frame 304 in order to generate the aligned non-reference frame 322. In some cases, a weighted perspective model can be used to generate a transformation matrix that is applied to the non-reference frame 304. This alignment process can be performed for each non-reference frame 304.

Note that in the example alignment process above, it may be assumed that tile-based registration and feature-based registration are performed across the entirety of the reference frame 302 and each non-reference frame 304. However, this need not be the case. For instance, the processor 120 of the electronic device 101 may perform image segmentation to identify various segments of the input image frames 202 and apply tile-based registration and/or feature-based registration based on the results of the segmentation. As a particular example, tile-based registration may be performed across the entirety of the reference frame 302 and the non-reference frame 304, while feature-based registration may be performed only in one or more segments of the reference frame 302 and the non-reference frame 304 associated with the sky or other more-uniform portion(s) of the scene. As another particular example, tile-based registration may be performed in one manner in one or more segments of the reference frame 302 and the non-reference frame 304 associated with the sky or other more-uniform portion(s) of the scene and in a different manner in one or more other segments of the reference frame 302 and the non-reference frame 304 associated with other scene content.

The reference frame and the aligned non-reference image frame(s) are blended to generate a blended image at step 1116. This may include, for example, the processor 120 of the electronic device 101 performing a multi-frame blending operation to combine the image data of the reference frame 302 and the aligned non-reference frame(s) 304. The blended image may be further processed to generate an output image of the scene at step 1118. This may include, for example, the processor 120 of the electronic device 101 performing any desired post-processing operation(s) of the blended image to generate an output image 216. The output image may be stored, output, or used at step 1120. This may include, for example, the processor 120 of the electronic device 101 presenting the output image 216 on the display 160 of the electronic device 101, saving the output image 216 to a camera roll stored in a memory 130 of the electronic device 101, or attaching the output image 216 to a text message, email, or other communication to be transmitted from the electronic device 101. Note, however, that the output image 216 could be used in any other or additional manner.

Although FIG. 11 illustrates one example of a method 1100 for robust frame registration for multi-frame image processing, various changes may be made to FIG. 11. For example, while shown as a series of steps, various steps in FIG. 11 may overlap, occur in parallel, occur in a different order, or occur any number of times (including zero times).

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple image frames capturing a scene;
selecting, using the at least one processing device, a reference frame among the image frames; and
aligning, using the at least one processing device, each of one or more non-reference frames among the image frames with the reference frame by:
performing tile-based registration of the non-reference frame to the reference frame;
performing feature-based registration of the non-reference frame to the reference frame;
aggregating first motion vectors generated during the tile-based registration and second motion vectors generated during the feature-based registration; and
warping the non-reference frame based on the aggregated motion vectors to generate an aligned non-reference frame.

2. The method of claim 1, wherein, for each non-reference frame, performing the tile-based registration comprises:
dividing the non-reference frame into tiles;
comparing each tile in the non-reference frame to a neighborhood of tiles in the reference frame;
selecting a tile in the neighborhood of tiles in the reference frame based on the comparison; and
generating at least one of the first motion vectors based on the selected tile in the neighborhood of tiles in the reference frame.

3. The method of claim 1, wherein, for each non-reference frame, performing the feature-based registration comprises:
extracting features from the non-reference frame;
comparing each feature in the non-reference frame to a corresponding feature in the reference frame;
selecting one or more of the features based on the comparison; and
generating at least one of the second motion vectors based on the one or more selected features.

4. The method of claim 1, wherein, for each non-reference frame, warping the non-reference frame based on the aggregated motion vectors comprises:
determining a warping of the non-reference frame based on the aggregated motion vectors; and
applying the warping to the non-reference frame in order to generate the aligned non-reference frame.

5. The method of claim 4, wherein, for each non-reference frame, determining the warping of the non-reference frame based on the aggregated motion vectors comprises:
using a weighted perspective model to generate a transformation matrix to be applied to the non-reference frame.

6. The method of claim 1, further comprising:
performing segmentation of the image frames to identify different portions of the scene captured in the image frames; and
identifying one or more segments in the image frames associated with a sky within the scene;
wherein at least one of the tile-based registration or the feature-based registration is performed in the one or more segments in the image frames associated with the sky and is not performed or is performed differently in other segments in the image frames associated with other portions of the scene.

7. The method of claim 1, further comprising:
blending the reference frame and the one or more aligned non-reference frames to generate a final image of the scene.

8. An electronic device comprising:
at least one imaging sensor configured to capture multiple image frames of a scene; and
at least one processing device configured to:
obtain the image frames;
select a reference frame among the image frames; and
align each of one or more non-reference frames among the image frames with the reference frame;
wherein, to align each non-reference frame with the reference frame, the at least one processing device is configured to:
perform tile-based registration of the non-reference frame to the reference frame;
perform feature-based registration of the non-reference frame to the reference frame;
aggregate first motion vectors generated during the tile-based registration and second motion vectors generated during the feature-based registration; and
warp the non-reference frame based on the aggregated motion vectors to generate an aligned non-reference frame.

9. The electronic device of claim 8, wherein, to perform the tile-based registration, the at least one processing device is configured, for each non-reference frame, to:
divide the non-reference frame into tiles;
compare each tile in the non-reference frame to a neighborhood of tiles in the reference frame;
select a tile in the neighborhood of tiles in the reference frame based on the comparison; and
generate at least one of the first motion vectors based on the selected tile in the neighborhood of tiles in the reference frame.

10. The electronic device of claim 8, wherein, to perform the feature-based registration, the at least one processing device is configured, for each non-reference frame, to:
extract features from the non-reference frame;
compare each feature in the non-reference frame to a corresponding feature in the reference frame;
select one or more of the features based on the comparison; and
generate at least one of the second motion vectors based on the one or more selected features.

11. The electronic device of claim 8, wherein, to warp each non-reference frame, the at least one processing device is to:
determine a warping of the non-reference frame based on the aggregated motion vectors; and
apply the warping to the non-reference frame in order to generate the aligned non-reference frame.

12. The electronic device of claim 11, wherein, to determine the warping of each non-reference frame, the at least one processing device is configured to use a weighted perspective model to generate a transformation matrix to be applied to the non-reference frame.

13. The electronic device of claim 8, wherein the at least one processing device is further configured to:
perform segmentation of the image frames to identify different portions of the scene captured in the image frames; and
identify one or more segments in the image frames associated with a sky within the scene; and
wherein the at least one processing device is configured to perform at least one of the tile-based registration or the feature-based registration in the one or more segments in the image frames associated with the sky, at least one of the tile-based registration or the feature-based registration not performed or performed differently in other segments in the image frames associated with other portions of the scene.

14. The electronic device of claim 8, further comprising:
blending the reference frame and the one or more aligned non-reference frames to generate a final image of the scene.

15. A non-transitory machine readable medium containing instructions that when executed cause at least one processor to:
obtain multiple image frames capturing a scene;
select a reference frame among the image frames; and
align each of one or more non-reference frames among the image frames with the reference frame;
wherein the instructions that when executed cause the at least one processor to align each non-reference frame with the reference frame comprise instructions that when executed cause the at least one processor to:
perform tile-based registration of the non-reference frame to the reference frame;
perform feature-based registration of the non-reference frame to the reference frame;
aggregate first motion vectors generated during the tile-based registration and second motion vectors generated during the feature-based registration; and
warp the non-reference frame based on the aggregated motion vectors to generate an aligned non-reference frame.

16. The non-transitory machine readable medium of claim 15, wherein the instructions that when executed cause the at least one processor to perform the tile-based registration comprise:
instructions that when executed cause the at least one processor, for each non-reference frame, to:
divide the non-reference frame into tiles;
compare each tile in the non-reference frame to a neighborhood of tiles in the reference frame;
select a tile in the neighborhood of tiles in the reference frame based on the comparison; and
generate at least one of the first motion vectors based on the selected tile in the neighborhood of tiles in the reference frame.

17. The non-transitory machine readable medium of claim 15, wherein the instructions that when executed cause the at least one processor to perform the feature-based registration comprise:
instructions that when executed cause the at least one processor, for each non-reference frame, to:
extract features from the non-reference frame;
compare each feature in the non-reference frame to a corresponding feature in the reference frame;
select one or more of the features based on the comparison; and
generate at least one of the second motion vectors based on the one or more selected features.

18. The non-transitory machine readable medium of claim 15, wherein the instructions that when executed cause the at least one processor to warp each non-reference frame comprise:
instructions that when executed cause the at least one processor, for each non-reference frame, to:
determine a warping of the non-reference frame based on the aggregated motion vectors; and
apply the warping to the non-reference frame in order to generate the aligned non-reference frame.

19. The non-transitory machine readable medium of claim 18, wherein the instructions that when executed cause the at least one processor to warp each non-reference frame comprise:
instructions that when executed cause the at least one processor to use a weighted perspective model to generate a transformation matrix to be applied to the non-reference frame.

20. The non-transitory machine readable medium of claim 15, further containing instructions that when executed cause the at least one processor to:
perform segmentation of the image frames to identify different portions of the scene captured in the image frames; and
identify one or more segments in the image frames associated with a sky within the scene;
wherein the instructions when executed cause the at least one processor to perform at least one of the tile-based registration or the feature-based registration in the one or more segments in the image frames associated with the sky, at least one of the tile-based registration or the feature-based registration not performed or performed differently in other segments in the image frames associated with other portions of the scene.
